(19) United States
(12) Patent Application Publication
(10) Pub. No.: US 2003/0222362 A1
(43) Pub. Date: Dec. 4, 2003

(54) Process for extracting biomedical devices

(75) Inventors: Erik M. Indra, Moorpark, CA (US); Madhu Ayyagari, Fairport, NY (US); Mahendra P. Nandu, Pittsford, NY (US)

Correspondence Address: Bausch & Lomb Incorporated, One Bausch & Lomb Place, Rochester, NY, 14604-2701, US

(73) Assignee: Bausch & Lomb Incorporated, Rochester, NY

(21) Appl. No.: 10/392,741

(22) Filed: Mar. 19, 2003

Related U.S. Application Data
(60) Provisional application No. 60/368,623, filed on Mar. 28, 2002.

(51) Int. Cl. B29D 11/00; B29C 71/00

(52) U.S. Cl. 264/2.6; 264/344

(57) ABSTRACT

A process for treating biomedical devices, especially contact lenses, involves contacting polymeric devices containing extractables with a solvent that dissolves and removes the extractables from the devices. The devices are subjected to at least two treatments with fresh solvent to remove extractables in the devices.

### FIELD OF THE INVENTION

The present invention relates to a process for removing extractables from polymeric biomedical devices, particularly ophthalmic devices including contact lenses, intraocular lenses and ophthalmic implants.

### BACKGROUND OF THE INVENTION

Hydrogels represent a desirable class of materials for the manufacture of various biomedical devices, including contact lenses. A hydrogel is a hydrated cross-linked polymeric system that contains water in an equilibrium state. Hydrogel lenses offer desirable biocompatibility and comfort.

In a typical process for the manufacture of hydrogel polymeric ophthalmic devices, such as contact lenses, a composition containing a mixture of lens-forming monomers is charged to a mold and cured to polymerize the lens-forming monomers and form a shaped article. This monomer mixture may further include a diluent, in which case the diluent remains in the resulting polymeric article. Additionally, some of these lens-forming monomers may not be fully polymerized, and oligomers may be formed from side reactions of the monomers, these unreacted monomers and oligomers remaining in the polymeric article. Such residual materials may affect optical clarity or irritate the eye when the ophthalmic article is worn, so generally, the articles are extracted to remove the residual articles. Hydrophilic residual materials can be extracted by water or aqueous solutions, whereas hydrophobic residual materials generally involve extraction with an organic solvent. One common organic solvent is isopropanol, a water-miscible organic solvent. Following extraction, the hydrogel lens article is hydrated by soaking in water or an aqueous solution, which may also serve to replace the organic solvent with water. The molded lens can be subjected to machining operations such as lathe cutting, buffing, and polishing, as well as packaging and sterilization procedures.

### SUMMARY OF THE INVENTION

This invention provides an improved process for producing biomedical devices, particularly ophthalmic biomedical devices, and removing extractables in the devices. The process comprises: contacting a batch of the devices containing extractables therein with a first volume of fresh solvent to remove some of the extractables from devices in the batch, and separating the batch of the devices from the first volume of solvent that now contains some of the extractables; followed by contacting the same batch of devices with a second volume of fresh solvent, to remove additional extractables from devices in this batch, and separating the batch of the devices from the second volume of solvent that now contains the additional extractables. Optionally, this batch may be contacted with additional volumes of fresh solvent to remove yet more extractables. Preferably, after completion of treatment of the batch of devices with solvent, the devices are contacted with water or an aqueous solution that replaces solvent remaining in the devices.

This invention ensures more uniform extraction efficiency among multiple batches of extracted lenses. Additionally, it has been found that the process of this invention may be used to reduce the amount of solvent and/or reduce the total extraction time required to remove extractables from a given number of polymeric biomedical devices.

### BRIEF DESCRIPTION OF THE DRAWINGS

FIG. 1 is a schematic representation of an apparatus and process for carrying out various preferred embodiments of this invention.

FIG. 2 is an exploded view of a lens support tray assembly that may be used in this invention.

FIG. 3 is a top plan view of the lens support tray of FIG. 2.

FIG. 4 is an exploded view of an alternate lens support tray assembly that may be used in this invention.

FIG. 5 is a bottom plan view of the top support plate of the tray assembly of FIG. 4.

FIG. 6 is a top plan view of the bottom support plate of the tray assembly of FIG. 4.

### DETAILED DESCRIPTION OF VARIOUS PREFERRED EMBODIMENTS

The present invention provides a method for removing extractables from biomedical devices, especially ophthalmic biomedical devices. The term “biomedical device” means a device intended for direct contact with living tissue. The term “ophthalmic biomedical device” means a device intended for direct contact with ophthalmic tissue, including contact lenses, intraocular lenses and ophthalmic implants. In the following description, the process is discussed with particular reference to hydrogel contact lenses, a preferred embodiment of this invention, but the invention may be employed for extraction of other polymeric biomedical devices.

A hydrogel is a hydrated cross-linked polymeric system that contains water in an equilibrium state. Hydrogel lenses are generally formed by polymerizing a mixture of lens-forming monomers including at least one hydrophilic monomer. Hydrophilic lens-forming monomers include: unsaturated carboxylic acids such as methacrylic acid and acrylic acid; (meth)acrylic substituted alcohols or glycols such as 2-hydroxyethyl methacrylate, 2-hydroxyethyl acrylate, and glyceryl methacrylate; vinyl lactams such as N-vinyl-2-pyrrolidone; and acrylamides such as methacrylamide and N,N-dimethylacrylamide. Other hydrophilic monomers are well-known in the art.

The monomer mixture generally includes a crosslinking monomer, a crosslinking monomer being defined as a monomer having multiple polymerizable functionalities. One of the hydrophilic monomers may function as a crosslinking monomer or a separate crosslinking monomer may be employed. Representative crosslinking monomers include: divinylbenzene, allyl methacrylate, ethylene glycol dimethacrylate, tetraethyleneglycol dimethacrylate, polyethyleneglycol dimethacrylate, and vinyl carbonate derivatives of the glycol dimethacrylates.

One class of hydrogels are silicone hydrogels, wherein the lens-forming monomer mixture includes, in addition to a hydrophilic monomer, at least one silicone-containing monomer. When the silicone-containing monomer includes multiple polymerizable radicals, it may function as the crosslinking monomer. This invention is particularly suited for extraction of silicone hydrogel biomedical devices. Generally, unreacted silicone-containing monomers, and oligomers formed from these monomers, are hydrophobic and more difficult to extract from the polymeric device. Therefore, efficient extraction generally requires treatment with an organic solvent such as isopropanol.

One suitable class of silicone containing monomers include known bulky, monofunctional polysiloxanylalkyl monomers represented by Formula (I):

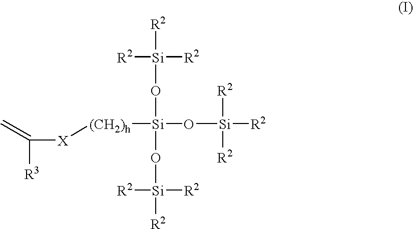

X denotes —COO—, —CONR⁴—, —OCOO—, or —OCONR⁴— where each where R⁴ is H or lower alkyl; R³ denotes hydrogen or methyl; h is 1 to 10; and each R² independently denotes a lower alkyl or halogenated alkyl radical, a phenyl radical or a radical of the formula

—Si(R⁵)₃

wherein each R⁵ is independently a lower alkyl radical or a phenyl radical. Such bulky monomers specifically include methacryloxypropyl tris(trimethylsiloxy)silane, pentamethyldisiloxanyl methylmethacrylate, tris(trimethylsiloxy)methacryloxy propylsilane, methyldi(trimethylsiloxy)methacryloxymethyl silane, 3-[tris(trimethylsiloxy)silyl] propyl vinyl carbamate, and 3-[tris(trimethylsiloxy)silyl] propyl vinyl carbonate.

Another suitable class are multifunctional ethylenically “end-capped” siloxane-containing monomers, especially difunctional monomers represented Formula (II):

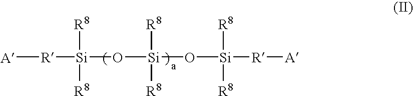

wherein:

each A′ is independently an activated unsaturated group;

each R′ is independently are an alkylene group having 1 to 10 carbon atoms wherein the carbon atoms may include ether, urethane or ureido linkages therebetween;

each R⁸ is independently selected from monovalent hydrocarbon radicals or halogen substituted monovalent hydrocarbon radicals having 1 to 18 carbon atoms which may include ether linkages therebetween, and

a is an integer equal to or greater than 1. Preferably, each R⁸ is independently selected from alkyl groups, phenyl groups and fluoro-substituted alkyl groups. It is further noted that at least one R⁸ may be a fluoro-substituted alkyl group such as that represented by the formula:

-D′-(CF₂)ₛ-M′

wherein:

D′ is an alkylene group having 1 to 10 carbon atoms wherein said carbon atoms may include ether linkages therebetween;

M′ is hydrogen, fluorine, or alkyl group but preferably hydrogen; and

s is an integer from 1 to 20, preferably 1 to 6.

With respect to A′, the term “activated” is used to describe unsaturated groups which include at least one substituent which facilitates free radical polymerization, preferably an ethylenically unsaturated radical. Although a wide variety of such groups may be used, preferably, A′ is an ester or amide of (meth)acrylic acid represented by the general formula:

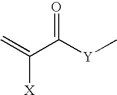

wherein X is preferably hydrogen or methyl, and Y is —O— or —NH—. Examples of other suitable activated unsaturated groups include vinyl carbonates, vinyl carbamates, fumarates, fumaramides, maleates, acrylonitryl, vinyl ether and styryl. Specific examples of monomers of Formula (II) include the following:

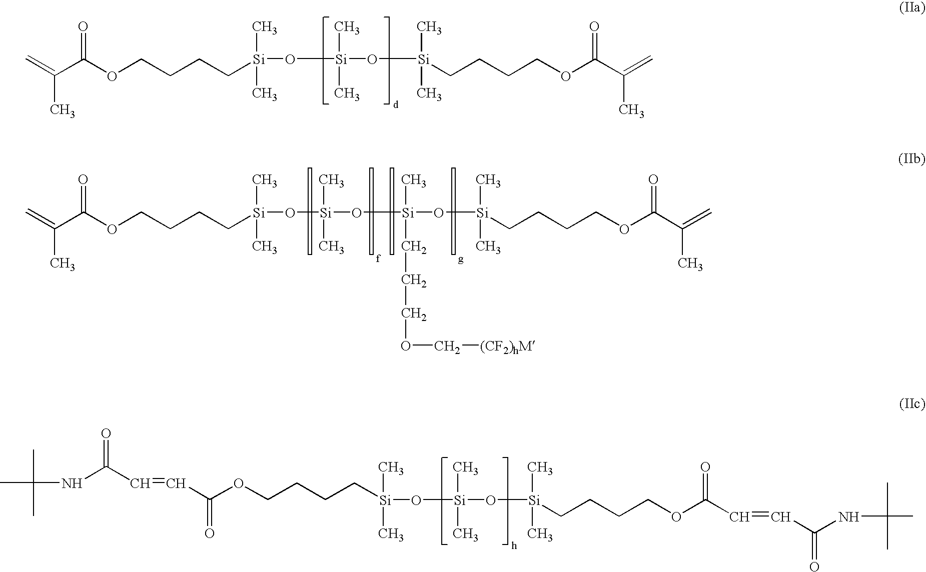

wherein:

d, f, g and k range from 0 to 250, preferably from 2 to 100; h is an integer from 1 to 20, preferably 1 to 6; and

M′ is hydrogen or fluorine.

A further suitable class of silicone-containing monomers includes monomers of the Formulae (IIIa) and (IIIb):

E′(*D*A*D*G)ₐ*D*A*D*E′; (IIIa)

or

E′(*D*G*D*A)ₐ*D*G*D*E′; (IIIb)

wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

a is at least 1;

A denotes a divalent polymeric radical of the formula:

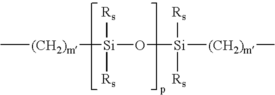

wherein:

each R^{z} independently denotes an alkyl or fluoro-substituted alkyl group having 1 to 10 carbon atoms which may contain ether linkages between carbon atoms;

m′ is at least 1; and

p is a number which provides a moiety weight of 400 to 10,000;

each E′ independently denotes a polymerizable unsaturated organic radical represented by the formula:

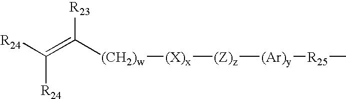

wherein:

R₂₃ is hydrogen or methyl;

R₂₄ is hydrogen, an alkyl radical having 1 to 6 carbon atoms, or a —CO—Y—R₂₆ radical wherein Y is —O—, —S— or —NH—;

R₂₅ is a divalent alkylene radical having 1 to 10 carbon atoms; R₂₆ is a alkyl radical having 1 to 12 carbon atoms; X denotes —CO— or —OCO—; Z denotes —O— or —NH—; Ar denotes an aromatic radical having 6 to 30 carbon atoms; w is 0 to 6; x is 0 or 1; y is 0 or 1; and z is 0 or 1.

A specific urethane monomer is represented by the following:

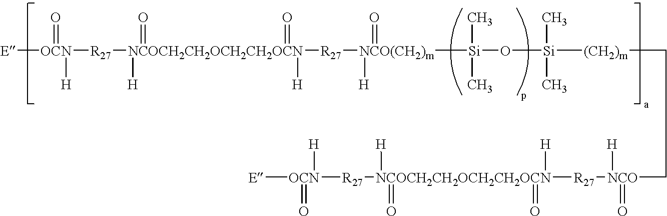

wherein m is at least 1 and is preferably 3 or 4, a is at least 1 and preferably is 1, p is a number which provides a moiety weight of 400 to 10,000 and is preferably at least 30, R₂₇ is a diradical of a diisocyanate after removal of the isocyanate group, such as the diradical of isophorone diisocyanate, and each E″ is a group represented by:

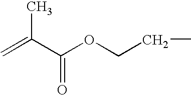

Other silicone-containing monomers include the silicone-containing monomers described in U.S. Pat. Nos. 5,034,461, 5,070,215, 5,260,000, 5,610,252 and 5,496,871, the disclosures of which are incorporated herein by reference. Other silicone-containing monomers are well-known in the art.

As mentioned, an organic diluent may be included in the initial monomeric mixture. As used herein, the term “organic diluent” encompasses organic compounds that are substantially unreactive with the components in the initial mixture, and are often used to minimize incompatibility of the monomeric components in this mixture. Representative organic diluents include: monohydric alcohols, such as C₆-C₁₀ monohydric alcohols; diols such as ethylene glycol; polyols such as glycerin; ethers such as diethylene glycol monoethyl ether; ketones such as methyl ethyl ketone; esters such as methyl heptanoate; and hydrocarbons such as toluene.

Generally, the monomer mixtures may be charged to a mold, and then subjected to heat and/or light radiation, such as UV radiation, to effect curing, or free radical polymerization, of the monomer mixture in the mold. Various processes are known for curing a monomeric mixture in the production of contact lenses or other biomedical devices, including spincasting and static casting. Spincasting methods involve charging the monomer mixture to a mold, and spinning the mold in a controlled manner while exposing the monomer mixture to light. Static casting methods involve charging the monomer mixture between two mold sections forming a mold cavity providing a desired article shape, and curing the monomer mixture by exposure to heat and/or light. In the case of contact lenses, one mold section is shaped to form the anterior lens surface and the other mold section is shaped to form the posterior lens surface. If desired, curing of the monomeric mixture in the mold may be followed by a machining operation in order to provide a contact lens or article having a desired final configuration. Such methods are described in U.S. Pat. Nos. 3,408,429, 3,660,545, 4,113,224, 4,197,266, 5,271,875, and 5,260,000, the disclosures of which are incorporated herein by reference. Additionally, the monomer mixtures may be cast in the shape of rods or buttons, which are then lathe cut into a desired shape, for example, into a lens-shaped article.

Removal of extractable components from polymeric contact lenses is typically carried out by contacting the lenses with an extraction solvent for a period of time sufficient to ensure substantially complete removal of the components. For example, according to one known method, a first batch of contact lenses may be immersed in a bath of isopropanol and held for several hours to effect removal of extractables such as unreacted monomers and oligomers from the lenses. This batch of lenses is removed from the bath, and a new batch of lenses is then immersed in the same bath. After several additional hours, this second batch is removed, and the process is repeated, until eventually the spent isopropanol in the bath is replaced with fresh isopropanol.

In the isopropanol bath, the concentration of extractables builds up as lens extraction proceeds and results in decreased efficiency in the removal of extractable material from later-treated lenses. Thus, even though all the lenses extracted by a bath of isopropanol may meet finished product specifications, there is a tendency for latter batches of lenses, extracted near the end of the solvent bath lifetime, to contain higher levels of residual extractables than batches treated earlier in its lifetime. Maintaining uniform extraction efficiency during the lifetime of the solvent bath is desirable and could obviously be achieved by lowering the number of lenses treated by a given quantity of solvent, but this would be undesirable from both an economic and an environmental standpoint as it would require higher volumes of solvent for a given number of lenses. Alternatively, extraction efficiency could be maintained by continuously replenishing the solvent; again, however, this approach may require higher volumes of solvent for a given number of lenses and result in generation of larger amounts of contaminated solvent requiring disposal.

The process of the present invention provides a desirable way of ensuring more uniform extraction efficiency among multiple batches of extracted lenses, while offering the opportunity to minimize the amount of solvent required to remove extractables from a given number of polymeric biomedical devices and/or reducing the total extraction time. In either case, cost savings and improved efficiencies for larger scale commercial manufacturing may be realized.

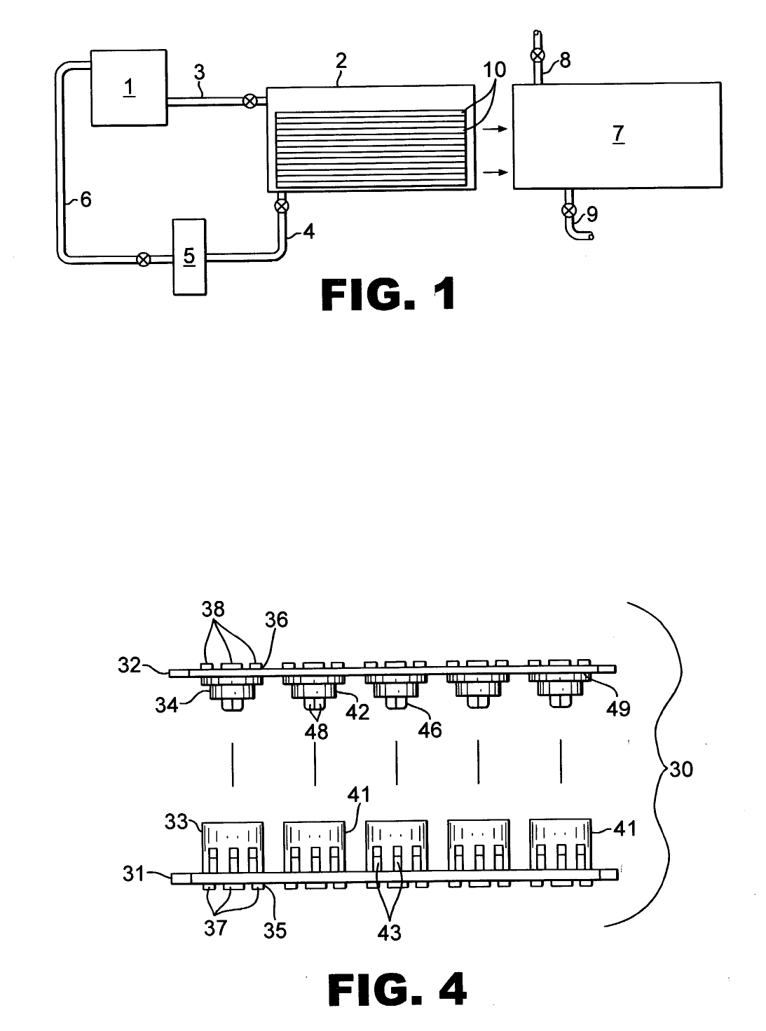

FIG. 1 illustrates schematically an apparatus and process for carrying out the invention according to various preferred embodiments. Fresh solvent, for example, isopropanol, is stored in vessel 1. A batch of polymeric biomedical devices, for example, contact lenses, are loaded into tank 2. In the illustrated embodiment, the batch of contact lenses is composed of several trays 10 stacked vertically, each tray 10 containing multiple contact lenses. A predetermined volume of fresh solvent from vessel 1 is then pumped into tank 2 through line 3, this volume being sufficient to immerse the stack of trays 10. If desired, the solvent in tank 2 can be agitated to enhance its circulation in the tank and about the trays 10, for example, tank 2 may be equipped with a mechanical stirrer, or ultrasonic waves may be employed for the agitation. This batch of trays 10 is contacted with this first volume of solvent for a predetermined time. As in conventional extraction processes, the solvent penetrates the devices and dissolves various extractables within the devices, such as unreacted monomers and oligomers. Then, the solvent in tank 2 is drained through line 4, whereby the extractables dissolved in the solvent are removed from tank 2 with the solvent.

This spent volume of solvent drained from tank 2 may be disposed of, or optionally, this volume may be subjected to a purification device 5 to remove the extractables therefrom, with purified solvent being returned to vessel 1 via line 6. It is understood that the term “fresh solvent” as used herein is inclusive of solvent that was previously used for extraction but purified to remove extractables therefrom. Representative purification devices include a packed bed or fluidized bed containing an adsorbing agent, such as activated carbon. Such methods of removing extractables from a solvent are disclosed in WO 01/23066 (U.S. application Ser. No. 09/667,902, filed Sep. 22, 2000), the disclosure of which is incorporated herein by reference.

Then, tank 2, still containing the same batch of trays 10, is refilled with a predetermined volume of fresh solvent from tank 1, and the lenses in this same batch of trays 10 is contacted with this second volume of solvent for a predetermined time, whereby additional extractables not removed by the first volume of solvent are dissolved in this fresh volume of solvent. Again, the solvent in tank 2 is drained through line 4, whereby the additional extractables dissolved in the solvent are removed from tank 2 with the solvent. Optionally, the batch of devices in trays 10 may be subjected to one or more additional treatments with fresh solvent if desired.

After the level of extractables in the devices in trays 10 has been reduced to a desired level, trays 10 may be transferred to tank 7. Tank 7 is filled with water or an aqueous solution, such as a buffered saline solution, through supply line 8, so as to immerse all trays 10 in the water or aqueous solution. The water or aqueous solution serves to rinse solvent from the devices, and thus, a water-miscible organic solvent is preferred so that it can easily be removed from the devices. Also, in the case of hydrogel copolymers, the water or aqueous solution is absorbed by the devices and replaces any organic solvent contained in the polymeric material. Stated differently, the water or aqueous solution flushes solvent from the devices. Tank 7 may optionally be provided with agitation, similar to tank 2, to facilitate circulation of the water or aqueous solution about the devices in trays 10. After a predetermined period of time, the water or aqueous solution is drained through line 9. Preferably, this batch of devices is subjected to at least one more treatment with water or aqueous solution in tank 7.

Subsequently, the trays 10 may be removed from tank 7 for additional processing. For example, in the case of contact lenses, the lenses can be packaged and sterilized.

Various trays for holding the devices are known in the art. Generally, the trays should retain the lenses or devices so they are not misplaced during extraction, and the trays should permit good circulation of solvent about the lenses or devices.

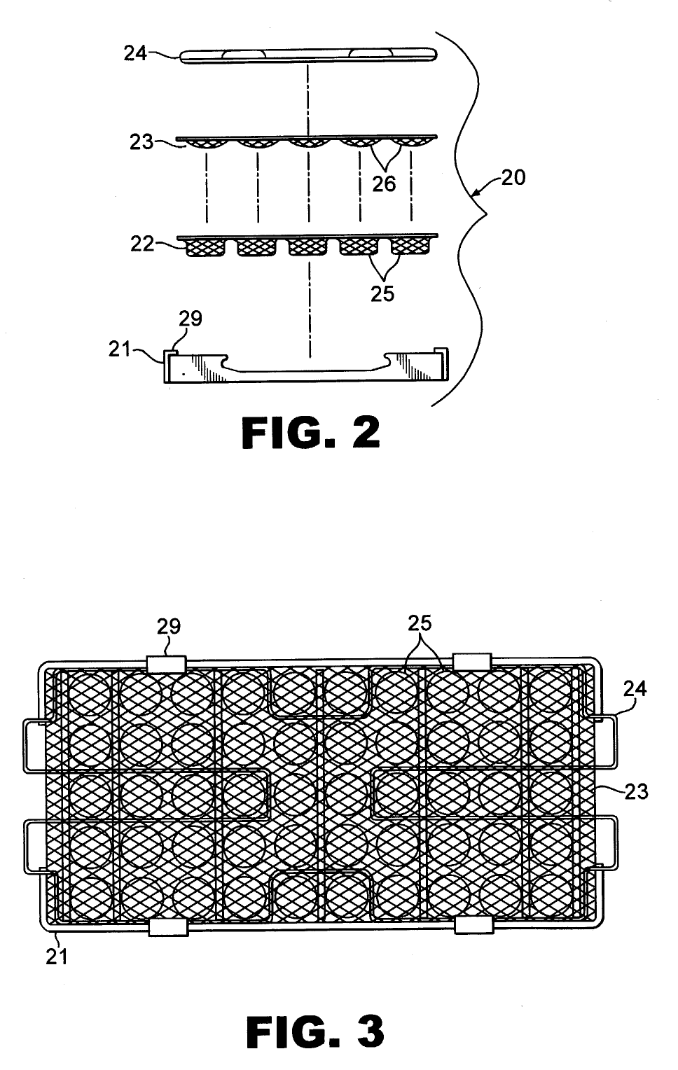

Representative trays are described in WO 01/32408 (U.S. application Ser. No. 09/684,644, filed Oct. 10, 2000), the disclosure of which is incorporated herein by reference. A support tray assembly of the type described in WO 01/32408 is shown in FIGS. 2 and 3. This assembly 20 includes: a bottom support 21 which may be constructed of stainless steel or other relatively rigid, corrosion-resistant material; a bottom mesh insert 22 and a top mesh insert 23, each of which may be constructed of a relatively flexible plastic such as polypropylene; and a top support 24 which may be constructed of a material similar to bottom support 21. Bottom mesh insert 22 has a plurality of wells 25 for holding individual contact lenses, and the top mesh insert has corresponding depressions 26 formed therein to assist in retaining a lens in each well 25. In assembling the assembly, as shown in FIG. 3, the bottom mesh insert 22 is placed in bottom support 21. Contact lenses may then be placed in wells 25, convex-side-down, either manually or with automated equipment. Then, the top mesh insert 23 is placed on top of bottom mesh insert 22, and top support 24 is added to secure the assembly together. For the illustrated embodiment, the assembly includes clips 29 and recesses 28 in the bottom support that receives the top support in order to secure the top support to the bottom support.

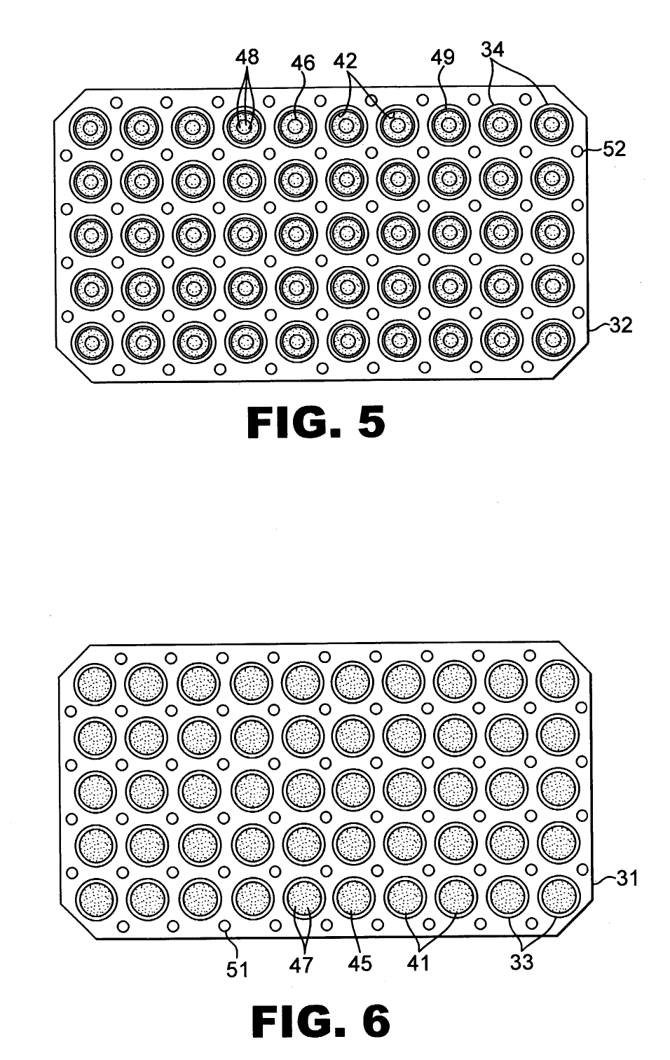

An additional tray assembly is shown in FIGS. 4, 5 and 6. This tray assembly 30 includes a bottom support plate 31 with a plurality of bottom inserts 33 inserted in holes 35 in plate 31, and a top support plate 32 with a plurality of top inserts 34 inserted in holes 36 in plate 32. The assembly components may be molded from a plastic such as polypropylene, although if desired the components could be machined from a corrosion-resistant metal. The bottom inserts 33 have a generally cylindrical shell 41, one end of which has clips 37 for retaining the inserts 33 in holes 35. The top inserts 34 have a generally cylindrical shell 42 extending from a flange 49, one end of which also has clips 38 for retaining the inserts 34 in holes 36. The inner diameter of shell 41 is sized to closely match the outer diameter of shell 42, so that shell 42 is received within shell 41 when the assembly is assembled. Shell 41 includes lateral openings 43 to permit circulation of solvent. Shell 41 also includes a slightly concave upper surface 45, best seen in FIG. 6, for supporting a contact lens on its convex surface, this surface 45 including holes 47 for facilitating circulation of solvent. Shell 42 includes a slightly convex lower surface 46 that includes holes 48, best seen in FIG. 5, for facilitating circulation of solvent. Accordingly, each shell 41 of inserts 33, along with a corresponding insert 34, forms a receptacle for receiving an individual contact lens. In assembling the assembly 30, contact lenses are placed convex-side-down on surfaces 43 of inserts 33, either manually or with automated equipment. Then, the top support plate 32 is placed on top of bottom support plate 31, so that each lens is contained in the receptacles formed by inserts 33, 34. If desired, clips or guide pins (not shown) may be inserted in one or more holes 51,52 of the two plates to hold these plates together and/or guide them into place, with any remaining holes 51, 52 facilitating circulation of solvent.

The following examples further illustrate various preferred embodiments of the invention.

### EXAMPLE 1

A lot of balafilcon A contact lenses, manufactured by a static cast molding process, was obtained. Balafilcon A is a silicone hydrogel material, further described in U.S. Pat. No. 5,260,000. Finished lenses made of this material are sold by Bausch & Lomb Incorporated (Rochester, N.Y., USA) under the PureVision trademark. This lot of lenses was subdivided into five sublots, and subjected to extraction with isopropanol according to the process illustrated in FIG. 1. The test results are summarized in Table 1.

TABLE 1

| | Number | | | Time Per | Total IPA | Total |
|---|---|---|---|---|---|---|
| | of | Tray | Number of | Extraction | Volume Per | Extraction |
| Test | Lenses | Type | Extractions | (min) | Lens (ml) | Time (min) |
| Control | 100 | A | 1 | 240 | 32.8 | 240 |
| Test 1 | 1050 | B | 3 | 20 | 32.4 | 60 |
| Test 2 | 1050 | B | 2 | 30 | 21.6 | 60 |
| Test 3 | 550 | A | 2 | 30 | 35.0 | 60 |
| Test 4 | 550 | A | 2 | 60 | 35.0 | 120 |

In Table 1, Tray Type A corresponds to the tray illustrated in FIGS. 4-6. Accordingly, as each tray holds fifty contact lenses, in the Control Test, only two trays were stacked in tank 2, whereas in Tests 3 and 4, eleven trays were stacked vertically. Tray Type B corresponds to the tray illustrated in FIGS. 2 and 3. Accordingly, as this tray holds fifty contact lenses, in Tests 1 and 2, twenty-one trays were stacked vertically in tank 2 having a 3-4 gallon capacity.

The “Number of Extractions” denotes the number of times the respective sublot of lenses was subjected to fresh isopropanol, and the “Time per Extraction” denotes the approximate minutes for each extraction cycle. The “Total Extraction Time” is based on the “Number of Extractions” times the “Time per Extraction”. It is noted that the actual “Time per Extraction” for Tests 1, 2, 3 and 4 reported in Table 1 was adjusted slightly so that the “Total Extraction Time” for these tests included the time required for refilling and draining of isopropanol between extractions. In other words, the actual “Time per Extraction” was adjusted to include time for refilling and draining.

Following the isopropanol extraction, the lenses were transferred to a water tank 7, and hydrated with purified water two times, ten minutes per water treatment. The lenses were inspected and packaged in vials and sterilized in an autoclave. Samples of fully processed lenses from each sublot were evaluated for content of extractables, and the results are reported in Table 2.

TABLE 2

| | | Monomer + | Monomer |
|---|---|---|---|
| Test | Conditions | Oligomer (μg/mg) | (μg/mg) |
| Control | Tray A | 3.1 | 0.09 |
| | 1 × 240 min | | |
| Test 1 | Tray B | 6.1 | 0.01 |
| | 3 × 20 min | | |
| Test 2 | Tray B | 5.4 | 0.05 |
| | 2 × 30 min | | |
| Test 3 | Tray A | 4.9 | 0.09 |
| | 2 × 30 min | | |
| Test 4 | Tray A | 2.9 | 0.04 |
| | 2 × 60 min | | |
| Target | — | <5.0 | <0.3 |
| Level | | | |

In Table 2, “Monomer+Oligomer” denotes the content of an unreacted silicone-containing monomer and isocyanate-containing oligomer. “Monomer” denotes the content of this same unreacted monomer. “Target Level” denotes a level of these residuals considered acceptable.

As seen in Tables 1 and 2, all variants in Tests 1, 2, 3 and 4 employed significantly lower Total Extraction Time than the Control Test, offering the opportunity for improved manufacturing efficiencies. Additionally, Test 3 employed significantly less isopropanol per lens than the Control yet still met target levels of extractables. Test 4, although employing slightly more isopropanol per lens than the Control, resulted in lower levels of extractables. In each of Tests 1, 2, 3 and 4, more uniform extraction among various batches of lenses would be obtained than prior methods that reuse the same isopropanol bath for multiple batches of lenses.

Having thus described the preferred embodiment of the invention, those skilled in the art will appreciate that various modifications, additions, and changes may be made thereto without departing from the spirit and scope of the invention, as set forth in the following claims.

We claim:

1. A process for producing polymeric biomedical devices, comprising:
contacting a batch of the devices containing extractables therein with a first volume of fresh solvent to remove some extractables from said batch of the devices;
separating the batch of the devices from the first volume of solvent that contains said some extractables;
contacting said batch of the devices with a second volume of fresh solvent, to remove additional extractables from said batch of the devices; and
separating the batch of the devices from the second volume of solvent that contains said additional extractables.

2. The process of claim 1, wherein the batch of the devices is immersed in the first and second volumes of solvent.

3. The process of claim 1, wherein the solvent comprises isopropanol.

4. The process of claim 1, wherein said devices are ophthalmic biomedical devices.

5. The process of claim 4, wherein said devices are ophthalmic lenses.

6. The process of claim 5, wherein said devices are contact lenses.

7. The process of claim 6, wherein the contact lenses are composed of a silicone hydrogel copolymer.

8. The process of claim 1, wherein the devices are composed of a silicone hydrogel copolymer.

9. The process of claim 1, further comprising contacting said batch of the devices with a third volume of fresh solvent to remove additional extractables from said batch of the devices.

10. The process of claim 1, further comprising, following solvent extraction, contacting said batch of the devices with water or an aqueous solution, whereby water replaces solvent remaining in the devices.

11. The process of claim 10, wherein the batch of the devices are contacted with fresh water or fresh aqueous solution several times.

12. The process of claim 1, wherein volumes of solvent separated from the batch of the devices is purified to remove extractables therefrom, and the purified solvent is used for extraction of another batch of the devices.
